(19) United States
(12) Patent Application Publication
(10) Pub. No.: US 2013/0120100 A1
(43) Pub. Date: May 16, 2013

(54) COIL COMPONENT

(71) Applicant: TOKO, INC., Saitama (JP)

(72) Inventors: Nobuaki MURAMATSU, Saitama (JP); Takumi ARAI, Saitama (JP)

(73) Assignee: TOKO, INC., Saitama (JP)

(21) Appl. No.: 13/660,197

(22) Filed: Oct. 25, 2012

(30) Foreign Application Priority Data
Nov. 11, 2011 (JP) 2011-247051

(51) Int. Cl. H01F 17/04; H01F 17/00

(52) U.S. Cl. 336/221

(57) ABSTRACT

A coil component of the present disclosure includes: a coil having a first coil tier and a second coil tier with an outer diameter smaller than that of the first coil tier; and a core on which the coil is mounted. The second coil tier of the coil is in contact with the core.

### CROSS-REFERENCE TO RELATED APPLICATION

This application is based on Japanese Patent Application No. 2011-247051 filed with the Japan Patent Office on Nov. 11, 2011, the entire content of which is hereby incorporated by reference.

### BACKGROUND

1. Technical Field

The present disclosure relates to a coil component having a coil of wound wire and a core on which the coil is mounted.

2. Related Art

As an example of the conventional coil component, one for wireless charging has been known in the art. Such a coil component includes a coil and a plate-shaped core. The coil is made of a wound conductor wire. One of a lead wire is drawn out from an inner periphery of the coil. The other of a lead wire is drawn out from an outer periphery of the coil. The coil is attached to the plate-shaped core such that the side opposite to one through which the lead wire passes faces downward (see, for example, JP-A-H07-231586). In the case of the coil component for wireless charging, the conductor wire for forming the coil is configured to be as thick as possible with limited dimensions of the coil component, in order to minimize loss in the coil. Such a thick conductor wire includes, for example, two parallel wires and a litz wire. Alternatively, a coil having a two-tiered coil may be used as shown in FIG. 4. The coil shown in FIG. 4 is formed by bifilar-winding a conductor wire 41 having two parallel wires.

### SUMMARY

A coil component of the present disclosure includes: a coil having a first coil tier and a second coil tier with an outer diameter smaller than that of the first coil tier; and a core on which the coil is mounted. The second coil layer of the coil is in contact with the core.

### BRIEF DESCRIPTION OF DRAWINGS

FIG. 1 is a perspective view illustrating a coil component according to a first embodiment of the present disclosure;

FIG. 2 is a cross-sectional view schematically illustrating the first embodiment in a manufacturing process;

FIG. 3A is a top view illustrating a core of a coil component according to a second embodiment of the present disclosure;

FIG. 3B is a top view illustrating the coil component according to the second embodiment; and

FIG. 4 is a perspective view illustrating a conventional coil component.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In some cases, a wireless charging system provided with a coil component may include a coil having the standard-defined inductance value, maximum configuration, and the like.

Under these circumstances, in the conventional coil component provided with a coil having two-tier coil, the coil tiers have different overlapping states of their respective conductor wires. This is due to a fact that a space of a reel in a winding machine for winding the conductor wire does not accommodate the thickness of the conductor wire. Therefore, even if the conductor wire is bifilar-wound such that the two coil tiers have the same number of windings, the outer diameters of the respective two coil tiers may not coincide with each other. In such a coil, the inductance values of the respective two coil tiers are equal to each other. However, when the coil component having the coil and a core is installed in the wireless charging system, the coil component inconveniently tends to cause a decrease in its Q factor around 100 kHz. If the Q factor around 100 kHz decreases, the power transmission efficiency of the wireless charging system is deteriorates.

An object of the present disclosure is to provide a coil component that is able to achieve a high Q factor without changing an inductance value of a coil.

A coil component of the present disclosure includes: a coil having a first coil tier and a second coil tier with an outer diameter smaller than that of the first coil tier; and a core for mounting the coil thereon. The second coil tier of the coil is in contact with the core.

As a result, a high Q factor can be achieved without changing an inductance value of a coil.

A coil component (the present component) according to the present embodiment has a coil and a plate-shaped core. The coil has two coil tiers and lead wires. The two coil tiers are formed by winding two conductor wires, respectively. The lead wires are respectively drawn out from an inner periphery and an outer periphery of each of the two coil tiers. The coil is mounted on the plate-shaped core. The two conductor wires of the coil may form two parallel wires. The two conductor wires are bifilar-wound in parallel to a winding axis of the coil to form the two coil tiers. The two coil tiers have different outer diameters, one larger than the other. The coil is mounted on the core such that the smaller-diameter coil tier is in contact with the core. The lead wire on the inner periphery side is drawn out from the topside of each of the two coil tiers.

### Embodiments

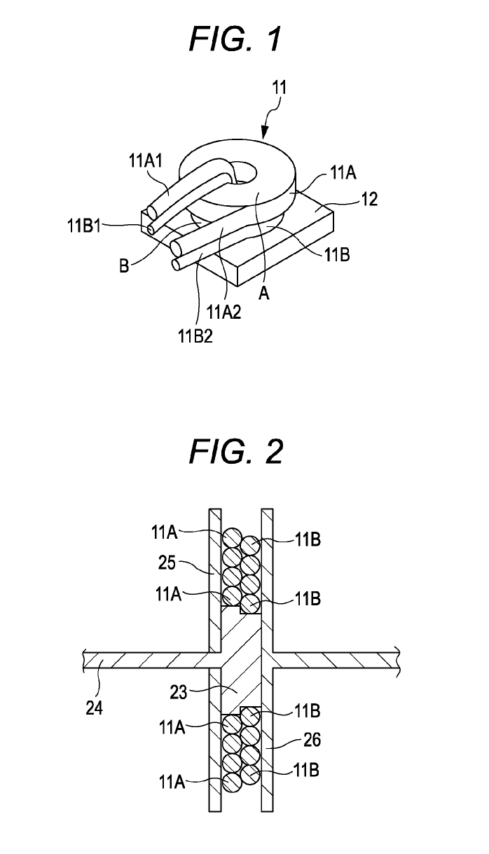

Hereinafter, embodiments of the present coil component will be described with reference to FIGS. 1, 2, 3A, and 3B.

FIG. 1 is a perspective view illustrating a first embodiment (first coil component) of the present coil component.

As illustrated in FIG. 1, the first coil component has a coil 11 and a core 12.

The coil 11 has a coil tier A and a coil tier B. The outer diameter of the coil tier A is larger than the outer diameter of the coil tier B. The coil tier A includes an insulation-coated conductor wire 11A. The coil tier B includes an insulation-coated conductor wire 11B. On forming the coil 11, the conductor wire 11A and the conductor wire 11B are arranged in parallel and fused together. As a result, two parallel wires, which respectively include the conductor wires 11A and 11B, are formed. The conductor wires 11A and 11B are bifilar-wound while being aligned in the direction parallel to a winding axis of the coil 11. As a result, the two coil tiers A and B are formed to have the same number of windings.

A lead wire 11A1 (one end of the conductor wire 11A) and a lead wire 11B1 (one end of the conductor wire 11B) are drawn out from the inner periphery of the coil 11. Moreover, a lead wire 11A2 (the other end of the conductor wire 11A) and a lead wire 11B2 (the other end of the conductor wire 11B) are drawn out from an outer periphery of the coil 11. The lead wires 11A1 and 11B1 on the inner periphery side of the coil 11 are drawn out from the topside of the coil tier A having the large outer diameter toward the outer periphery.

In the coil 11 thus configured, frequency characteristics of the Q factor of a single piece of the coil 11 are set such that the Q factor takes a maximum value at a frequency higher than 100 kHz, which is a frequency used in a wireless charging system.

The coil 11 is mounted on the core 12 such that the coil tier B having the small outer diameter faces (is in contact with) the core 12.

The core 12 includes a plate-shaped ferrite member. A bottom surface of the coil tier B is bonded by an adhesive to a top surface of the core 12.

The first coil component having the above-described configuration is manufactured as follows. FIG. 2 is a cross-sectional view schematically illustrating a process of manufacturing the coil 11 in the first coil component.

First, two insulation-coated conductor wires 11A and 11B are arranged in parallel and fused together. As a result, two parallel wires, which respectively include the conductor wires 11A and 11B, are formed. The two parallel wires are wound by a winding machine.

A surface of the winding machine (i.e. a surface of a reel 23) is provided with a step. The winding machine has a reel 23, a shaft 24, a first flange 25, and a second flange 26. The reel 23 has a small-diameter part and a large-diameter part. The reel 23 is rotated by the shaft 24. The first flange 25 is provided on the side of the large-diameter part of the reel 23. The second flange 26 is provided on the side of the small-diameter part of the reel 23. When the conductor wire is wound, the second flange 26 rotates with the reel 23 while being in contact with the small-diameter part of the reel 23.

The conductor wire 11A of the two parallel wires are arranged on the large-diameter part of the reel 23. On the other hand, the conductor wire 11B of the two parallel wires are arranged on the small-diameter part of the reel 23.

With this state, the reel 23 of the winding machine is rotated, and thereby the two parallel wires are bifilar-wound. The two parallel wound wires are detached from the reel 23 by detaching the flange 26 from the reel 23 of the winding machine. As a result, the coil 11 including the coil tier A having the large outer diameter and the coil tier B having the small outer diameter is formed.

The coil 11 is bonded to the plate-shaped core 12 such that the coil tier B faces the core 12. The lead wires 11A1 and 11B1 are drawn out from the inner periphery side of the coil 11. Moreover, the lead wires 11A1 and 11B1 are drawn out from the topside of the coil tier A to the outer periphery thereof.

In the case of the first coil component thus manufactured, if the coil tier A having the large outer diameter is bonded to the core 12, the frequency characteristics of the Q factor of the first coil component become totally smaller. Therefore, the Q factor of the first coil component around 100 kHz becomes lower than that of the coil 11 alone. On the other hand, if the coil tier B having the small outer diameter is bonded to the core, the frequency characteristics of the Q factor of the first coil component shifts toward the lower frequency side as compared with a case of the coil 11 alone. As described above, the frequency characteristics of the Q factor of the coil 11 alone are set such that the Q factor takes a maximum value at a frequency higher than 100 kHz, which is a frequency used in the wireless charging system. Therefore, according to the first coil component, the Q factor at a frequency around 100 kHz used in the wireless charging system can be increased.

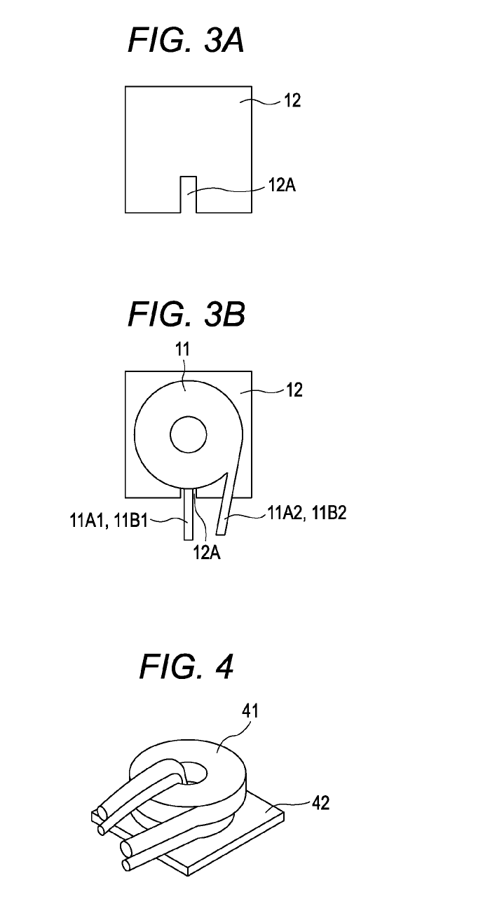

FIG. 3A is a top view illustrating a core in a second embodiment (second coil component) of the present coil component, and FIG. 3B is a top view illustrating the second coil component.

The second coil component has almost the same configuration as the first coil component. A difference between the first coil component and the second coil component will be described below. In the case of the coil 11 of the second coil component, the lead wires 11A1 and 11B1 on the inner periphery side are drawn out from the bottom side of the coil tier B having the small outer diameter to the outer periphery.

The coil 11 thus configured is mounted on the core 12 such that the coil tier B having the small outer diameter faces the core 12.

In the case of the second coil component, the core 12 has a slit 12A. A bottom surface of the coil tier B having the small outer diameter is bonded by an adhesive to a top surface of the core 12. The lead wires 11A1 and 11B1 on the inner periphery side of the coil 11 extends outward through the slit 12A.

The embodiments of the present coil component have been described above. However, the present coil component is not limited to these embodiments. For example, the core 12 may include a magnetic sheet. Also, the core 12 may include a metal magnetic sheet. Furthermore, the surface of the reel 23 of the winding machine may not be provided with a step. In this case, a gap between the first flange 25 and the second flange 26 may be configured to be slightly smaller than the width of the two parallel wires, and the two parallel wires may be arranged obliquely with respect to the surface of the reel 23.

In the embodiments described above, the two parallel wires are used as the conductor wires of the coil 11. However, in the present coil component, two litz wires arranged in parallel may be used as the conductor wires (winding wires) of the coil 11.

In the first coil component, one end of the lead wire 11A and one end of the lead wire 11B of the two parallel wires may be respectively arranged on the large-diameter part of the reel 23 and the small-diameter part of the reel 23 such that the two lead wires 11A and 11B are arranged in parallel on the surface of the reel 23 of the winding machine.

The winding machine for manufacturing the coil 11 may have: a reel whose surface is not provided with a step; a shaft for rotating the reel; a flange provided for the reel; and another flange that is in contact with the reel and rotates in conjunction with the reel when a winding wire is wound, wherein the two flanges are formed such that a gap between the two flanges is slightly smaller than the width of two parallel wires, and the two parallel wires are arranged obliquely with respect to a surface of the reel.

The coil component according to the present disclosure may have: a coil in which two coil tiers are formed by winding a winding wire and lead wires are respectively drawn out from an inner periphery and an outer periphery of the two coil tiers; and a plate-shaped core on which the coil is mounted. Regarding the coil, the winding wire may be formed of two parallel wires, and the two coil tiers may be formed by bifilar-winding the two parallel wires with being arranged along the direction parallel to a winding axis of the coil. The two coil tiers may be formed such that the outer diameter of one coil tier is larger than the outer diameter of the other coil tier. The coil may be mounted on the core such that the coil tier having the smaller outer diameter is in contact with the core. The lead wire on the inner periphery side may be drawn out from the topside of the coil tier having the larger outer diameter.

The present coil component may be one of the following third to fifth coil component. The third coil component is one that includes: a coil and a core, where the coil has first and second tiers formed by winding respective winding wires. Here, the coil is configured such that the outer diameter of the first tier is different from that of the second tier, and the tier having the smaller outer diameter is mounted on the core.

The fourth coil component is the one according to the third coil component. Here, the core has a slit, and a lead wire is drawn out from an inner periphery of the coil and introduced into the slit of the core.

The fifth coil component is the one according to the third or fourth coil component. Here, the core is a magnetic sheet.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A coil component comprising:
a coil comprising:
a first coil tier; and
a second coil tier having an outer diameter smaller than an outer diameter of the first coil tier; and
a core on which the coil is mounted,
wherein the second coil tier of the coil is in contact with the core.

2. The coil component according to claim 1,
wherein each of the first coil tier and the second coil tier includes an inner periphery side lead wire drawn out from an inner periphery thereof,
the core includes a slit section, and
the inner periphery side lead wire extends outward through the slit section.

3. The coil component according to claim 1,
wherein the core includes a magnetic sheet.

4. The coil component according to claim 2,
wherein the core includes a magnetic sheet.
